(19) United States
(12) Patent Application Publication
(10) Pub. No.: US 2011/0186544 A1
(43) Pub. Date: Aug. 4, 2011

(54) METHOD OF ACCELERATING SELF-ASSEMBLY OF BLOCK COPOLYMER AND METHOD OF FORMING SELF-ASSEMBLED PATTERN OF BLOCK COPOLYMER USING THE ACCELERATING METHOD

(75) Inventors: Masayuki ENDOU, Osaka (JP); Masaru SASAGO, Osaka (JP)

(73) Assignee: PANASONIC CORPORATION, Osaka (JP)

(21) Appl. No.: 13/085,954

(22) Filed: Apr. 13, 2011

Related U.S. Application Data
(63) Continuation of application No. PCT/JP2009/004217, filed on Aug. 28, 2009.

(30) Foreign Application Priority Data
Nov. 12, 2008 (JP) 2008-289806

(51) Int. Cl. B05D 3/04; B05D 3/02; B05D 1/36

(52) U.S. Cl. 216/58; 427/385.5; 427/264

(57) ABSTRACT

A block copolymer film is formed on a substrate. Then, the block copolymer film is annealed in an inert-gas atmosphere, for example, in a neon atmosphere. This places the outside (mainly the upper portion) of the block copolymer film in a nonpolar state, thereby strongly drawing, for example, a monomer unit having hydrophobic characteristics outside the block copolymer film to accelerate self-assembly. This results in an improvement in throughput in self-assembled pattern formation of the block copolymer film.

### CROSS-REFERENCE TO RELATED APPLICATION

This is a continuation of PCT International Application PCT/JP2009/004217 filed on Aug. 28, 2009, which claims priority to Japanese Patent Application No. 2008-289806 filed on Nov. 12, 2008. The disclosures of these applications including the specifications, the drawings, and the claims are hereby incorporated by reference in their entirety.

### BACKGROUND

The present disclosure relates to methods of accelerating self-assembly of block copolymers used in pattern formation in manufacturing processes etc. of semiconductor devices and methods of forming self-assembled patterns of block copolymers using the accelerating methods.

With an increase in integration of semiconductor integrated circuits and downsizing of semiconductor elements, accelerated development of lithography techniques has been demanded. At present, pattern formation is performed by optical lithography using mercury lamps, KrF excimer laser, ArF excimer laser, or the like as exposure light.

Recently, immersion lithography has been suggested to promote further miniaturization of patterns using a conventional exposure wavelength. Use of extreme ultraviolet with a shorter wavelength has been also considered.

As a possible method for further miniaturized pattern formation, a bottom-up pattern formation is suggested instead of a bottom-down pattern formation. (See, e.g., Japanese Patent Publication No. 2008-149447). Specifically, the method is a self-assembled ultrafine pattern formation using a block copolymer made by copolymerizing polymer chains having first characteristics as monomer units with another polymer chains (monomer units) having different characteristics. According to the method, a block copolymer film is annealed so that the monomer units having different characteristics repel each other, and monomer units having the same characteristics tend to gather, thereby forming a pattern in a self-aligned manner (i.e., directional self-assembly).

A conventional pattern formation method using a block copolymer will be described hereinafter with reference to the drawings.

First, as shown in FIG. 7A, a block copolymer film 2 having the following composition and a thickness of 0.07 μm is formed on a substrate 1.

Poly(styrene (50 mol %)-methyl methacrylate (50 mol %))(block copolymer): 2 g

Propylene glycol monomethyl ether acetate (solvent): 10 g

Then, as shown in FIG. 7B, the formed block copolymer film 2 is annealed in an oven at a temperature of 180° C. for 24 hours to obtain a first pattern 2a and a second pattern 2b shown in FIG. 7C, each of which has a line width of 16 nm and a self-assembled lamellar structure (layer structure). Note that, in FIGS. 7A-7C, the block copolymer film 2 is formed inside a guide pattern, which is omitted in the figures.

### SUMMARY

However, in the pattern formation method using the conventional block copolymer, annealing for self-assembly of the block copolymer film requires long time such as about 24 hours. This is an obstacle to mass-production techniques in semiconductor manufacturing processes, resulting in difficulty in industrial application.

In view of the problems, it is an objective of the present disclosure to improve throughput in self-assembled pattern formation of a block copolymer.

After repeating various studies of self-assembly of block copolymers, the present inventors found that block copolymers are easily self-assembled by the following method during annealing of any one of a monomer unit, e.g., a hydrophilic or hydrophobic monomer unit, contained in the block copolymers.

First, when a block copolymer film is annealed in an inert-gas atmosphere, the outside (mainly the upper portion) of the block copolymer film is placed in a nonpolar state. This strongly draws, for example, a monomer unit (hydrophobic unit) having hydrophobic characteristics outside the film to accelerate self-assembly.

When the block copolymer film is annealed under humidified conditions, the outside (mainly the upper portion) of the block copolymer film is placed in a hydrophilic state. This strongly draws, for example, a monomer unit (hydrophilic unit) having hydrophilic characteristics outside the film to accelerate self-assembly. For example, introduction of moisture in an oven is used as a method of the humidification.

When a water-soluble polymer film is formed on the block copolymer film, the water-soluble polymer is formed on the upper surface of the block copolymer film. This strongly draws, for example, a monomer unit having hydrophilic characteristics outside (in the upper portion of) the film to accelerate self-assembly. While exposure with a water-soluble polymer film formed on a resist film is conventionally known, the present disclosure differs from the conventional method in forming patterns without exposure. The water-soluble polymer film is removed with water etc. after the annealing. When cured by the annealing, the water-soluble polymer film can be removed by ashing with oxygen plasma.

The block copolymer film according to the present disclosure is annealed, for example, in an oven at a temperature of about 150° C. or more. The annealing time can be significantly reduced in the present disclosure, for example, from about 2 hours to about 6 hours. The present disclosure is, however, not limited thereto.

The present disclosure was made based on the above findings. When annealing the block copolymer film, the atmosphere mainly in contact with the upper surface of the annealed block copolymer film is made hydrophilic or hydrophobic, or another film in contact with the upper surface is made hydrophilic or hydrophobic. Specifically, the present disclosure is achieved by the following methods.

A first method of accelerating self-assembly of a block copolymer according to the present disclosure includes forming a first film made of a block copolymer on a substrate, and annealing the first film in an inert-gas atmosphere.

In the first method of accelerating self-assembly of a block copolymer, since the first film made of the block copolymer is annealed in the inert-gas atmosphere, the outside (mainly the upper portion) of the first film is placed in a nonpolar state. This strongly draws, for example, a hydrophobic monomer unit outside the first film to accelerate self-assembly. This improves throughput in self-assembled pattern formation of the block copolymer.

In the first method of accelerating self-assembly of a block copolymer, the inert gas may be helium, neon, argon, krypton, or xenon.

A second method of accelerating self-assembly of a block copolymer according to the present disclosure includes forming a first film made of a block copolymer on a substrate; and annealing the first film under humidified conditions.

In the second method of accelerating self-assembly of a block copolymer, since the first film made of the block copolymer is annealed under humidified conditions, the outside (mainly the upper portion) of the first film is placed in a hydrophilic state. This strongly draws, for example, a hydrophilic monomer unit outside the first film to accelerate self-assembly. This improves throughput in self-assembled pattern formation of the block copolymer.

In the second method of accelerating self-assembly of a block copolymer, the annealing under the humidified conditions is preferably performed in a humidified atmosphere with humidity of 30% or more.

A third method of accelerating self-assembly of a block copolymer according to the present disclosure includes forming a first film made of a block copolymer on a substrate; forming a second film made of a water-soluble polymer on the first film; and annealing the first film and the second film.

In the third method of accelerating self-assembly of a block copolymer, since the second film made of the water-soluble polymer is formed on the first film made of the block copolymer, the water-soluble polymer is formed on the upper surface of the first film. This strongly draws, for example, a monomer unit having hydrophilic characteristics in the upper portion of the first film to accelerate self-assembly. This improves throughput in self-assembled pattern formation of the block copolymer.

In the third method of accelerating self-assembly of a block copolymer, the water-soluble polymer may be polyvinyl alcohol, polyvinylpyrrolidone, polyacrylic acid, or polystyrene sulfonate. Note that the second film made of the water-soluble polymer preferably has a thickness of about 50 nm or less.

In the first to third methods of accelerating self-assembly of a block copolymer, the block copolymer preferably contains a hydrophilic unit and a hydrophobic unit.

In this case, the hydrophilic unit may be methacrylate, butadiene, vinyl acetate, acrylate, acrylamide, acrylonitrile, acrylic acid, vinyl alcohol, ethylene glycol, or propylene glycol.

Also, in this case, the hydrophobic unit may be styrene, xylyen, or ethylene.

When the block copolymer contains two types of monomer units at a copolymerization ratio of 50:50, a self-assembled pattern has a lamellar structure. With a decrease in the ratio of one of the monomer units from this ratio, the structure becomes a cylinder structure or a dot structure.

A first method of forming a self-assembled pattern of a block copolymer according to the present disclosure includes forming on a substrate, a guide pattern having hydrophilic or hydrophobic characteristics and an opening; forming a first film made of a block copolymer in the opening of the guide pattern on the substrate; self-assembling the first film by annealing the first film in an inert-gas atmosphere; and forming a self-assembled pattern from the self-assembled first film.

According to the first method of forming a self-assembled pattern of the block copolymer, the first film made of the block copolymer is formed in the opening of the guide pattern having hydrophilic or hydrophobic characteristics and the opening, and then the first film is annealed in the inert-gas atmosphere. This accelerates the self-assembly of the first film as described above. This results in an improvement in throughput of the self-assembled pattern made of the block copolymer.

In the first method of forming a self-assembled pattern of a block copolymer, the inert gas may be helium, neon, argon, krypton, or xenon.

A second method of forming a self-assembled pattern of a block copolymer includes forming on a substrate, a guide pattern having hydrophilic or hydrophobic characteristics and an opening; forming a first film made of a block copolymer in the opening of the guide pattern on the substrate; self-assembling the first film by annealing the first film under humidified conditions; and forming a self-assembled pattern from the self-assembled first film.

In the second method of forming a self-assembled pattern of a block copolymer, the first film made of the block copolymer is formed in the opening of the guide pattern having hydrophilic or hydrophobic characteristics and the opening, and then the first film is annealed under humidified conditions. This accelerates the self-assembly of the first film as described above. This results in an improvement in throughput of the self-assembled pattern made of the block copolymer.

In the second method of forming a self-assembled pattern of a block copolymer, the annealing under the humidified conditions is preferably performed in a humidified atmosphere with humidity of 30% or more.

A third method of forming a self-assembled pattern of a block copolymer according to the present disclosure includes forming on a substrate, a guide pattern having hydrophilic or hydrophobic characteristics and an opening; forming a first film made of a block copolymer in the opening of the guide pattern on the substrate; forming a second film made of a water-soluble polymer on the first film; self-assembling the first film by annealing the first film and the second film; and forming a self-assembled pattern from the self-assembled first film after removing the second film.

In the third method of forming a self-assembled pattern of a block copolymer, the first film made of the block copolymer is formed in the opening of the guide pattern having hydrophilic or hydrophobic characteristics and the opening, and then the first film is annealed with the second film made of the water-soluble polymer formed thereon. Thus, the second film made of the water-soluble polymer accelerates the self-assembly of the first film as described above. This results in an improvement in throughput of the self-assembled pattern made of the block copolymer.

In the third method of forming a self-assembled pattern of the block copolymer, the water-soluble polymer may be polyvinyl alcohol, polyvinylpyrrolidone, polyacrylic acid, or polystyrene sulfonate.

In the first to third methods of forming a self-assembled pattern of the block copolymer, the block copolymer preferably contains a hydrophilic unit and a hydrophobic unit.

In this case, the hydrophilic unit may be methacrylate, butadiene, vinyl acetate, acrylate, acrylamide, acrylonitrile, acrylic acid, vinyl alcohol, ethylene glycol, or propylene glycol.

Also, in this case, the hydrophobic unit may be styrene, xylyen, or ethylene.

Also, in this case, in the forming the self-assembled pattern, the self-assembled pattern may be formed by etching a first pattern containing the hydrophilic unit, or a second pattern containing the hydrophobic unit.

The method of accelerating self-assembly of a block copolymer according to the present disclosure, and the method of forming a self-assembled pattern of a block copolymer using the accelerating method provide improved throughput in self-assembled pattern formation of a block copolymer.

### BRIEF DESCRIPTION OF THE DRAWINGS

FIGS. 1A-1D are cross-sectional views illustrating steps of a pattern formation method according to a first embodiment of the present disclosure.

FIG. 2 is a cross-sectional view illustrating a step of the pattern formation method according to the first embodiment.

FIGS. 3A-3D are cross-sectional views illustrating steps of a pattern formation method according to a second embodiment of the present disclosure.

FIG. 4 is a cross-sectional view illustrating a step of the pattern formation method according to the second embodiment.

FIGS. 5A-5D are cross-sectional views illustrating steps of a pattern formation method according to a third embodiment of the present disclosure.

FIGS. 6A and 6B are cross-sectional views illustrating steps of the pattern formation method according to the third embodiment.

FIGS. 7A-7C are cross-sectional views illustrating steps of a pattern formation method using a conventional block copolymer.

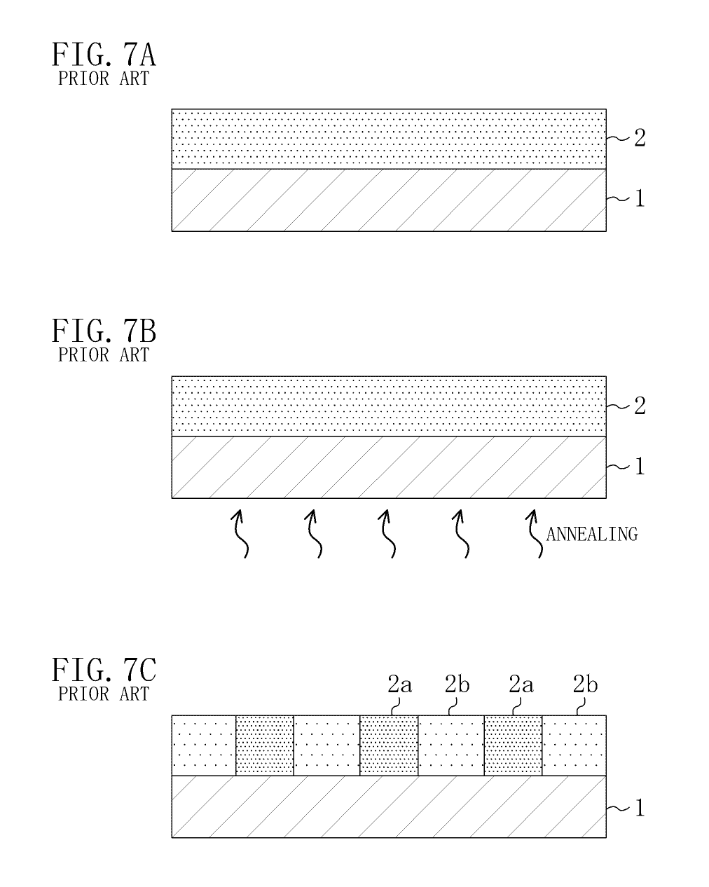

### DETAILED DESCRIPTION

### First Embodiment

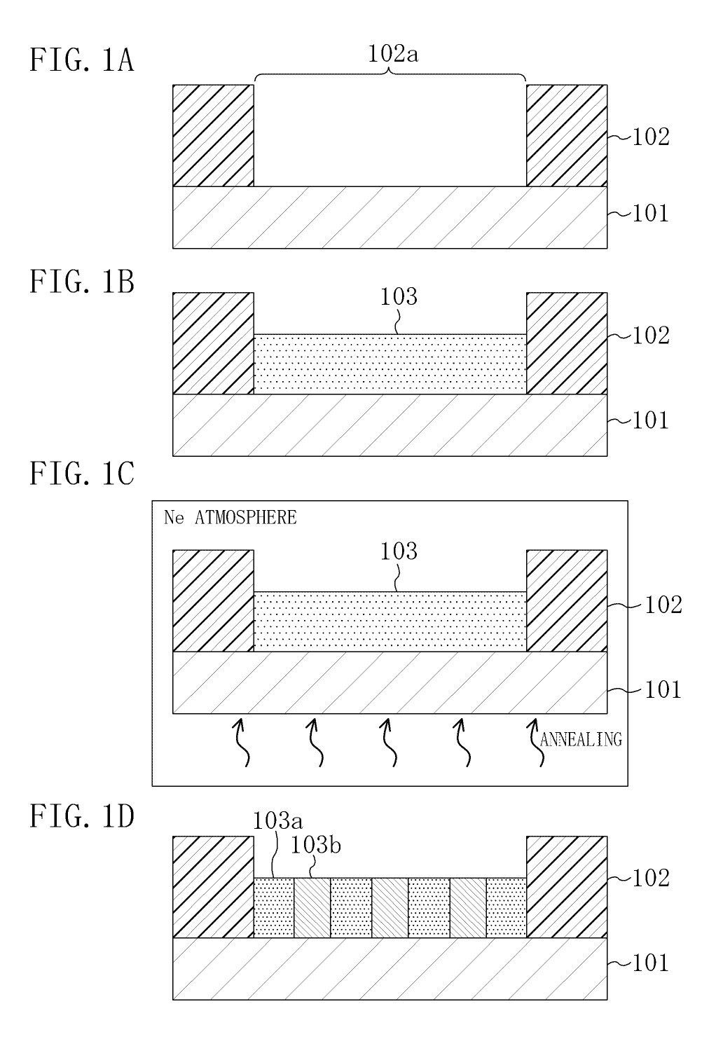

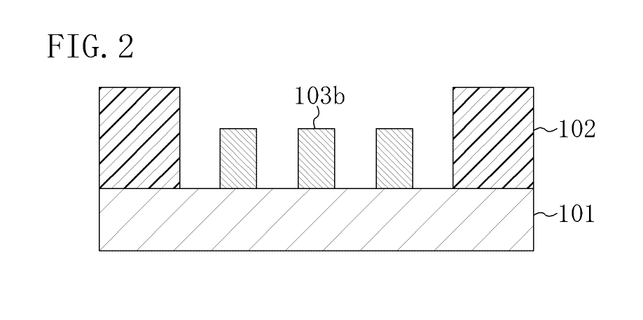

A pattern formation method using a block copolymer according to a first embodiment of the present disclosure will be described below with reference to FIGS. 1A-1D and 2.

First, as shown in FIG. 1A, the top of a substrate 101 is spin coated with a solution in which hydrophilic hydroxylated silsesquioxane is dissolved into methyl isobutyl ketone, and then baked with a hot plate at a temperature of 110° C. for 60 seconds to form a hydroxylated silsesquioxane film with a thickness of 40 nm. After that, the formed hydroxylated silsesquioxane film is selectively irradiated by electron beam exposure with a voltage of 100 kV. Then, the hydroxylated silsesquioxane film is developed with a tetramethylammonium hydroxide aqueous solution at a concentration of 2.3 wt % to form a guide pattern 102 having an opening 102a with a width of 30 nm from the hydroxylated silsesquioxane film.

Next, as shown in FIG. 1B, a block copolymer film 103 having the following composition and a thickness of 30 nm is formed in the opening 102a of the guide pattern 102.

Poly(styrene (60 mol %)-methyl methacrylate (40 mol %))(block copolymer): 2 g

Propylene glycol monomethyl ether acetate (solvent): 10 g

After that, as shown in FIG. 1C, the block copolymer film 103 is annealed in an oven in an atmosphere of neon (Ne), which is inert gas, at a temperature of 180° C. for about 3 hours. As a result, as shown in FIG. 1D, a first pattern 103a and a second pattern 103b, each of which is self-assembled in perpendicular to the substrate 101 and has a lamellar structure with a line width of 16 nm. Since the guide pattern 102 is made of hydrophilic hydroxylated silsesquioxane, the first pattern 103a in contact with a side surface of the guide pattern 102 contains hydrophilic polymethyl methacrylate as a main component, and the second pattern 103b inside the first pattern 103a contains hydrophobic polystyrene as a main component.

There is a significant difference in an etching rate to oxygen gas between polystyrene and polymethyl methacrylate. Specifically, polymethyl methacrylate has a higher etching rate than polystyrene. Thus, when the first pattern 103a is etched with oxygen gas, the second pattern 103b made of polystyrene can be formed by annealing for about 3 hours as shown in FIG. 2. Therefore, pattern formation using the block copolymer is applicable to a manufacturing process of a semiconductor device.

While the inert gas is neon (Ne) in this embodiment, helium (He), argon (Ar), krypton (Kr) or xenon (Xe), or mixed gas of two or more of them may be used instead.

### Second Embodiment

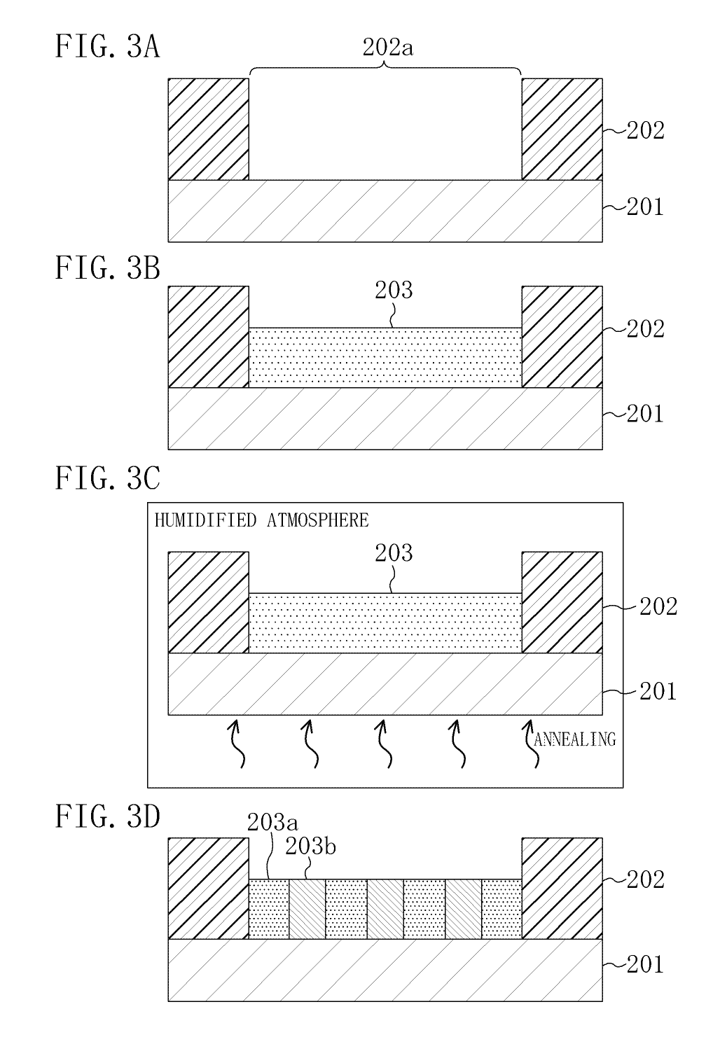

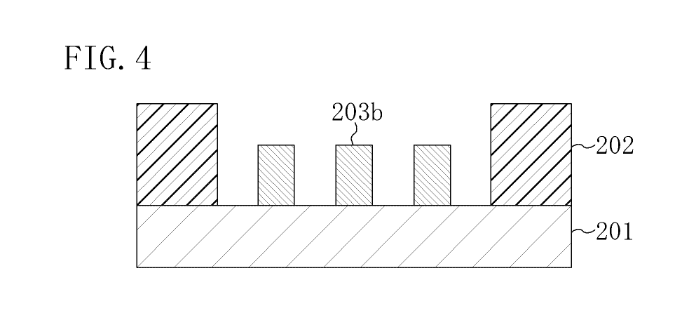

A pattern formation method using a block copolymer according to a second embodiment of the present disclosure will be described below with reference to FIGS. 3A-3D and 4.

First, as shown in FIG. 3A, the top of a substrate 201 is spin coated with a solution in which hydrophilic hydroxylated silsesquioxane is dissolved into methyl isobutyl ketone, and then baked with a hot plate at a temperature of 110° C. for 60 seconds to form a hydroxylated silsesquioxane film with a thickness of 40 nm. After that, the formed hydroxylated silsesquioxane film is selectively irradiated by electron beam exposure with a voltage of 100 kV. Then, the hydroxylated silsesquioxane film is developed with a tetramethylammonium hydroxide aqueous solution at a concentration of 2.3 wt % to form a guide pattern 202 having an opening 202a with a width of 30 nm from the hydroxylated silsesquioxane film.

Next, as shown in FIG. 3B, a block copolymer film 203 having the following composition and a thickness of 30 nm is formed in the opening 202a of the guide pattern 202.

Poly(styrene (40 mol %)-methyl methacrylate (60 mol %)(block copolymer): 2 g

Propylene glycol monomethyl ether acetate (solvent): 10 g

After that, as shown in FIG. 3C, steam is introduced around the block copolymer film 203, which is annealed in an oven under humidified conditions with humidity of 40% at a temperature of 190° C. for about 2 hours. As a result, as shown in FIG. 3D, a first pattern 203a and a second pattern 203b, each of which is self-assembled in perpendicular to the substrate 201 and has a lamellar structure with a line width of 16 nm. Since the guide pattern 202 is made of hydrophilic hydroxylated silsesquioxane, the first pattern 203a in contact with a side surface of the guide pattern 202 contains hydrophilic polymethyl methacrylate as a main component, and the second pattern 203b inside the first pattern 203a contains hydrophobic polystyrene as a main component.

Then, when the first pattern 203a and the second pattern 203b are etched with oxygen gas, the first pattern 203a with a high etching rate is etched, and the second pattern 203b made of polystyrene can be formed by annealing for about two hours as shown in FIG. 4. Therefore, pattern formation using the block copolymer is applicable to a manufacturing process of a semiconductor device.

While in this embodiment, the humidity at the time of annealing is set to about 40%, 30% or more of humidity may suffice.

### Third Embodiment

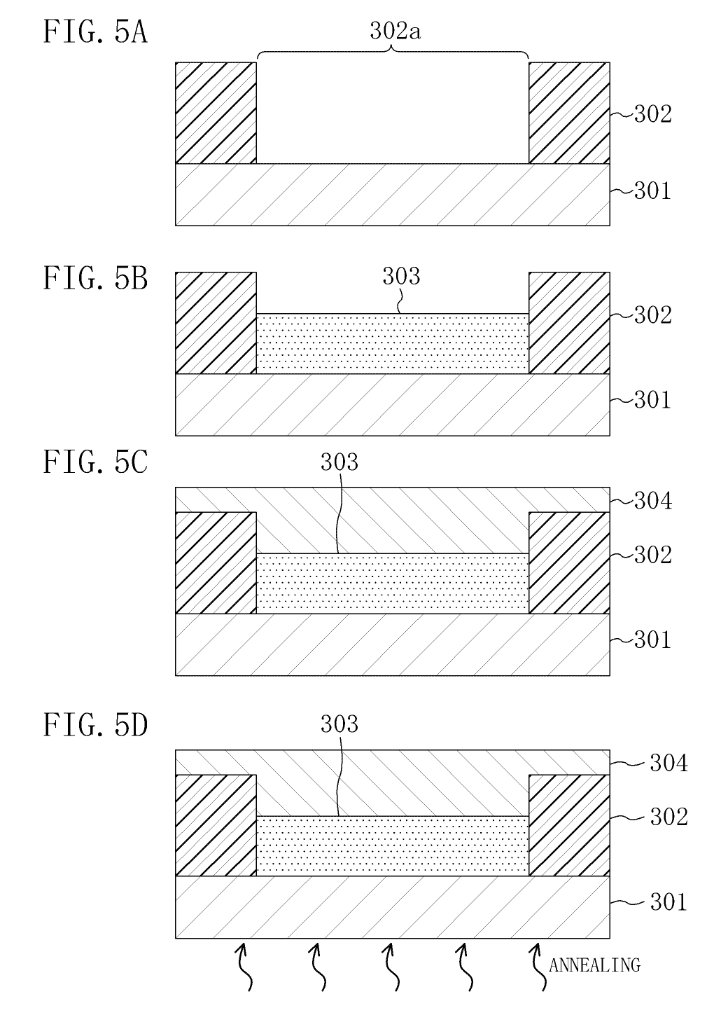

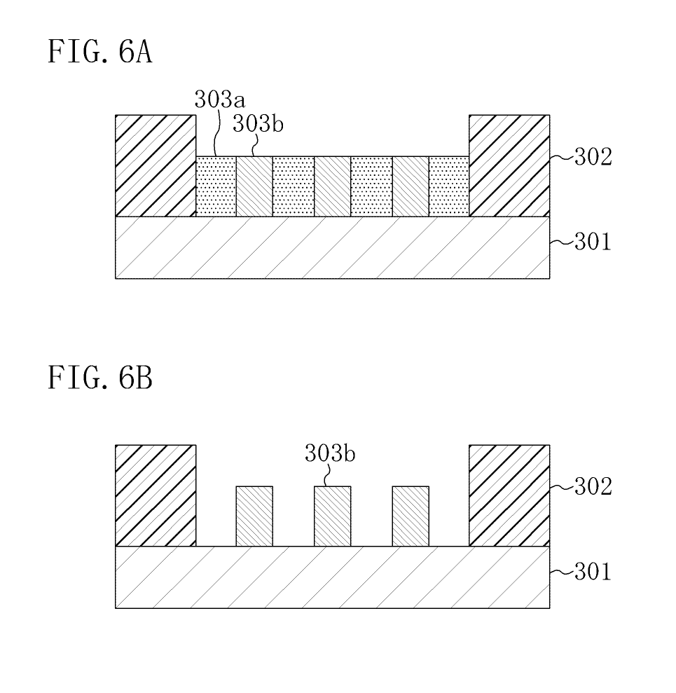

A pattern formation method using a block copolymer according to a third embodiment of the present disclosure will be described below with reference to FIGS. 5A-5D, 6A, and 6B.

First, as shown in FIG. 5A, the top of a substrate 301 is spin coated with a solution in which hydrophilic hydroxylated silsesquioxane is dissolved into methyl isobutyl ketone, and then baked with a hot plate at a temperature of 110° C. for 60 seconds to form a hydroxylated silsesquioxane film with a thickness of 40 nm. After that, the formed hydroxylated silsesquioxane film is selectively irradiated by electron beam exposure with a voltage of 100 kV. Then, the hydroxylated silsesquioxane film is developed with a tetramethylammonium hydroxide aqueous solution at a concentration of 2.3 wt % to form a guide pattern 302 having an opening 302a with a width of 30 nm from the hydroxylated silsesquioxane film.

Next, as shown in FIG. 5B, a block copolymer film 303 having the following composition and a thickness of 30 nm is formed in the opening 302a of the guide pattern 302.

Poly(styrene (50 mol %)-methyl methacrylate (50 mol %)(block copolymer): 2 g

Propylene glycol monomethyl ether acetate (solvent): 10 g

After that, as shown in FIG. 5C, a water-soluble polymer film 304 having a thickness of 20 nm and made of polyvinyl alcohol is formed on the block copolymer film 303.

Next, as shown in FIG. 5D, the water-soluble polymer film 304 and the block copolymer film 303 are annealed in an oven at a temperature of 180° C. for about 3 hours.

After that, the water-soluble polymer film 304 is removed with water etc. or ashed with oxygen gas to obtain a first pattern 303a and a second pattern 303b, each of which is self-assembled in perpendicular to the substrate 301 and has a lamellar structure with a line width of 16 nm as shown in FIG. 6A. Since the guide pattern 302 is made of hydrophilic hydroxylated silsesquioxane, the first pattern 303a in contact with a side surface of the guide pattern 302 contains hydrophilic polymethyl methacrylate as a main component, and the second pattern 303b inside the first pattern 303a contains hydrophobic polystyrene as a main component.

Then, when the first pattern 303a and the second pattern 303b are etched with oxygen gas, the first pattern 303a with a high etching rate is etched, and the second pattern 303b made of polystyrene can be formed by annealing for about three hours as shown in FIG. 6B. Therefore, pattern formation using the block copolymer is applicable to a manufacturing process of a semiconductor device.

While the water-soluble polymer film 304 is made of polyvinyl alcohol in this embodiment, polyvinylpyrrolidone, polyacrylic acid, or polystyrene sulfonate may be used instead.

While in this embodiment, the water-soluble polymer film 304 is also formed on the guide pattern 302, the water-soluble polymer film 304 may not cover the guide pattern 302 but may be formed only on the block copolymer film 303 depending on the thicknesses of the guide pattern 302, the block copolymer film 303, and the water-soluble polymer film 304.

While in the first to third embodiments, the hydrophilic unit included in the block copolymer film is made of methacrylate and the hydrophobic unit is made of styrene, the present disclosure is not limited thereto. For example, the hydrophilic unit may be butadiene, vinyl acetate, acrylate, acrylamide, acrylonitrile, acrylic acid, vinyl alcohol, ethylene glycol, or propylene glycol instead of methacrylate. The hydrophobic unit may be made of xylyen or ethylene instead of styrene. Furthermore, as long as the characteristics of the monomer unit are maintained, the monomer contained in the monomer unit is not necessarily a single monomer, and the monomer unit may be a polymer chain in which a plurality of monomers are mixed.

While the guide pattern is made of hydroxylated silsesquioxane, tetraalkoxysilane etc. may be used instead.

Note that, in the first to third embodiments, the lamellar structure in the direction perpendicular to the substrate is formed with the hydrophilic guide pattern. Therefore, the inert-gas atmosphere at the time of annealing in the first embodiment, the humidified atmosphere at the time of annealing in the second embodiment, and the water-soluble polymer film in the third embodiment are used to the degree necessary for accelerating the lamellar structure perpendicular to the substrate, and not damaging the lamellar structure.

The method of accelerating self-assembly of a block copolymer according to the present disclosure, and the method of forming a self-assembled pattern of a block copolymer using the accelerating method improve throughput in self-assembled pattern formation of the block copolymer, and is thus, useful for fine pattern formation in a manufacturing process of a semiconductor device.

What is claimed is:

1. A method of accelerating self-assembly of a block copolymer comprising:
forming a first film made of a block copolymer on a substrate;
forming a second film made of a water-soluble polymer on the first film; and
annealing the first film and the second film.

2. The method of claim 1, wherein
the water-soluble polymer is polyvinyl alcohol, polyvinylpyrrolidone, polyacrylic acid, or polystyrene sulfonate.

3. The method of claim 1, wherein
the block copolymer contains a hydrophilic unit and a hydrophobic unit.

4. The method of claim 3, wherein
the hydrophilic unit is methacrylate, butadiene, vinyl acetate, acrylate, acrylamide, acrylonitrile, acrylic acid, vinyl alcohol, ethylene glycol, or propylene glycol.

5. The method of claim 3, wherein
the hydrophobic unit is styrene, xylyen, or ethylene.

6. A method of accelerating self-assembly of a block copolymer comprising:
forming a first film made of a block copolymer on a substrate; and
annealing the first film under humidified conditions.

7. The method of claim 6, wherein
the annealing under the humidified conditions is performed in an atmosphere with a temperature of 150° C. or more.

8. The method of claim 7, wherein
the annealing under the humidified conditions is performed in a humidified atmosphere with humidity of 30% or more.

9. The method of claim 7, wherein
the block copolymer contains a hydrophilic unit and a hydrophobic unit.

10. The method of claim 9, wherein
the hydrophilic unit is methacrylate, butadiene, vinyl acetate, acrylate, acrylamide, acrylonitrile, acrylic acid, vinyl alcohol, ethylene glycol, or propylene glycol.

11. The method of claim 9, wherein
the hydrophobic unit is styrene, xylyen, or ethylene.

12. A method of accelerating self-assembly of a block copolymer comprising:
forming a first film made of a block copolymer on a substrate; and
annealing the first film in an inert-gas atmosphere, wherein
the inert gas is helium, neon, argon, krypton, or xenon.

13. The method of claim 12, wherein
the inert gas is helium, neon, krypton, or xenon.

14. The method of claim 12, wherein
the block copolymer contains a hydrophilic unit and a hydrophobic unit.

15. The method of claim 14, wherein
the hydrophilic unit is methacrylate, butadiene, vinyl acetate, acrylate, acrylamide, acrylonitrile, acrylic acid, vinyl alcohol, ethylene glycol, or propylene glycol.

16. The method of claim 14, wherein
the hydrophobic unit is styrene, xylyen, or ethylene.

17. A method of forming a self-assembled pattern of a block copolymer comprising:
forming on a substrate, a guide pattern having hydrophilic or hydrophobic characteristics and an opening;
forming a first film made of a block copolymer in the opening of the guide pattern on the substrate;
forming a second film made of a water-soluble polymer on the first film;
self-assembling the first film by annealing the first film and the second film; and
forming a self-assembled pattern from the self-assembled first film after removing the second film.

18. The method of claim 17, wherein
the water-soluble polymer is polyvinyl alcohol, polyvinylpyrrolidone, polyacrylic acid, or polystyrene sulfonate.

19. The method of claim 17, wherein
the block copolymer contains a hydrophilic unit and a hydrophobic unit.

20. The method of claim 19, wherein
in the forming of the self-assembled pattern, the self-assembled pattern is formed by etching a first pattern containing the hydrophilic unit, or a second pattern containing the hydrophobic unit.

21. A method of forming a self-assembled pattern of a block copolymer comprising:
forming on a substrate, a guide pattern having hydrophilic or hydrophobic characteristics and an opening;
forming a first film made of a block copolymer in the opening of the guide pattern on the substrate;
self-assembling the first film by annealing the first film under humidified conditions; and
forming a self-assembled pattern from the self-assembled first film, wherein
the block copolymer contains a hydrophilic unit and a hydrophobic unit, and
in the forming of the self-assembled pattern, the self-assembled pattern is formed by etching a first pattern containing the hydrophilic unit, or a second pattern containing the hydrophobic unit.

22. The method of claim 21, wherein
in the self-assembling of the first film, the annealing under the humidified conditions is performed in an atmosphere with a temperature of 150° C. or more.

23. The method of claim 21, wherein
the annealing under the humidified conditions is performed in a humidified atmosphere with humidity of 30% or more.

24. A method of forming a self-assembled pattern of a block copolymer comprising:
forming on a substrate, a guide pattern having hydrophilic or hydrophobic characteristics and an opening;
forming a first film made of a block copolymer in the opening of the guide pattern on the substrate;
self-assembling the first film by annealing the first film in an inert-gas atmosphere; and
forming a self-assembled pattern from the self-assembled first film, wherein
the inert gas is helium, neon, argon, krypton, or xenon.

25. The method of claim 24, wherein
the inert gas is helium, neon, krypton, or xenon.

26. The method of claim 25, wherein
the block copolymer contains a hydrophilic unit and a hydrophobic unit.

27. The method of claim 26, wherein
in the forming of the self-assembled pattern, the self-assembled pattern is formed by etching a first pattern containing the hydrophilic unit, or a second pattern containing the hydrophobic unit.
